(19) United States
(12) Patent Application Publication
(10) Pub. No.: US 2006/0043652 A1
(43) Pub. Date: Mar. 2, 2006

(54) Jig for firing ceramics, manufacturing method for a porous ceramic body, and porous ceramic body

(75) Inventors: Takamitsu Saijo, Ibi-gun (JP); Koji Higuchi, Ibi-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: IBIDEN CO., LTD., Ogaki-shi (JP)

(21) Appl. No.: 11/143,998

(22) Filed: Jun. 3, 2005

(30) Foreign Application Priority Data
Jul. 1, 2004 (JP) 2004-196047
Feb. 1, 2005 (WO) PCT/JP05/01423
Feb. 10, 2005 (WO) PCT/JP05/02076

(51) Int. Cl. C04B 35/64

(52) U.S. Cl. 264/671; 264/608

(57) ABSTRACT

A jig for firing ceramics, which is used by being piled up in multiple stages upon firing a ceramic formed body, of the present invention has a through hole and/or a cut-out portion formed in a portion thereof.

### CROSS-REFERENCE TO RELATED APPLICATIONS

This application claims benefit of priority to Japanese Patent Application No. 2004-196047, filed on Jul. 1, 2004, International Patent Application PCT/JP2005/001423, filed on Feb. 1, 2005 as well as to International Patent Application PCT/JP2005/002076, filed on Feb. 10, 2005, the contents of which are incorporated by reference herein in their entirety.

### BACKGROUND OF THE INVENTION

1. Field of the Invention

The present invention relates to: a jig for firing ceramics that is used for manufacturing a ceramic formed body; a manufacturing method for a porous ceramic body in which such a jig for firing ceramics is used; and a porous ceramic body manufactured by using the jig for firing ceramics.

2. Discussion of the Background

In recent years, particulates contained in exhaust gases that are discharged from internal combustion engines of vehicles, such as a bus, a truck and the like, construction machines and the like, have raised serious problems since those particulates are harmful to the environment and the human body.

Various ceramic filters made from porous ceramics, which purify exhaust gases by allowing exhaust gases to pass through the porous ceramics so as to collect particulates in the exhaust gases, have been proposed.

Normally, the ceramic filter has a structure in which a plurality of porous silicon carbide sintered bodies 50 serving as the porous ceramic bodies as shown in FIG. 9 are combined with one another through sealing material layer 41 with a sealing material layer 42 being formed on the periphery thereof. Here, each of the porous silicon carbide sintered bodies 50 has a structure in which, as shown in FIGS. 10A,B, a number of through holes 51 are placed in parallel one another in the length direction with a partition wall 53 that separates the through holes 51 functioning as a filter.

In other words, as shown in FIG. 10B, each of the through holes 51 that are formed in the porous silicon carbide sintered body 50 is sealed with a plug 52 at either one of ends on its exhaust-gas inlet side or outlet side so that exhaust gases that have entered one through hole 51 are discharged from another through hole 51 after having always passed through each partition wall 53 that separates the through holes 51; thus, when the exhaust gases pass through the partition wall 53, particulates are captured by the partition wall 53 so that the exhaust gases are purified.

Since the porous ceramic body 50 of this type has superior heat resistance and provides easy regenerating processes and the like, it has been applied to various large-size vehicles and vehicles with diesel engines.

Conventionally, upon manufacturing the porous silicon carbide sintered body of this type, first, silicon carbide powder, a binder and a dispersant solution are mixed with one another to prepare a mixed composition for manufacturing a formed body, and this mixed composition is subjected to an extrusion-forming process and the like to manufacture a silicon carbide formed body.

Next, the resulting silicon carbide formed body is dried by using a heater or the like to manufacture a dried body of a silicon carbide formed body that has predetermined strength, and can be easily handled.

After this drying process, the silicon carbide formed body is heated at 400° C. to 650° C. in an oxygen-containing atmosphere so that the solvent in the organic binder component is volatalized and degreasing processes to decompose and eliminate the resin component are carried out, and the resulting formed body is further subjected to a firing process in which silicon carbide powder is heated at 2000° C. to 2200° C. in an inert gas atmosphere to be sintered; thus, a porous silicon carbide sintered body is manufactured.

FIG. 11A is a plan view that schematically shows a jig for firing to be used in a conventional firing process for a silicon carbide formed body, and FIG. 11B is a front view that shows a state in which the jigs for firing are piled up in multiple stages and fired.

In the conventional firing process for a silicon carbide formed body, first, a plurality of silicon carbide formed bodies 32 that have been degreased are placed in a box-shaped jig for firing 60 with an opened upper face, as shown in FIG. 11A, and a plurality of the jigs for firing 60 having silicon carbide formed bodies 52 placed therein are piled up to form a piled-up body. After this piled-up body has been placed on a supporting base 61, the supporting base 61 is transported onto a shifting base 68 such as a conveyer belt, and the silicon carbide formed body 32 is heated and fired by a heater so that a porous silicon carbide sintered body is manufactured.

In the conventional firing process for a silicon carbide formed body of this type, the heating process is carried out in a piled-up state in which the jigs for firing having silicon carbide formed bodies placed thereon are piled up in multiple stages; thus the atmospheres inside the jigs for firing are completely isolated by the respective jigs for firing; consequently, dispersions tend to occur in the firing states of the respective silicon carbide formed bodies depending on the jigs for firing in which silicon carbide formed bodies are placed and portions inside the jigs for firing.

In other words, the porous silicon carbide sintered bodies, manufactured in this method, tend to have dispersions in the pore diameter depending on the respective porous silicon carbide sintered bodies, and also have dispersions in strength, and when a ceramic filter is manufactured by using the porous silicon carbide sintered body of this type, dispersions tend to occur in the strength and pore diameter therein. Moreover, cracks tend to occur in the sintered body.

So as to deal with such problems, the applicant of the present application has previously proposed the method: in which the remaining amount of carbon in the formed body is adjusted; and in which carbon powder and/or carbon particles are/is spread all over the bottom face of a jig for firing (for example, see Japanese Patent Laid-open Publication No. 2002-226271).

The contents of Japanese Patent Laid-open Publication No. 2002-226271 are incorporated herein by reference in their entirety.

### SUMMARY OF THE INVENTION

A jig for firing ceramics according to the present invention is the jig for firing ceramics, which is used by being piled up in multiple stages upon firing a ceramic formed body, having a through hole and/or a cut-out portion formed in a portion thereof.

It is desirable that the jig for firing ceramics according to the present invention either: has a box shape with its upper face opened; is configured by a substantially rectangular-shaped bottom portion, and wall portions formed on opposing two sides of the rectangular shape; is configured by a rectangular-shaped bottom portion, and pillar-shaped portions formed on four corners of the rectangular shape; or has a flat plate shape.

In case where the jig for firing ceramics according to the present invention has a box shape with its upper face opened, it is desirable: that the through hole and/or cur-out portion are/is formed only in a bottom face; or the through holes/or cur-out portion are/is formed in a bottom face and a wall portion.

In case where the jig for firing ceramics according to the present invention is configured by a substantially rectangular-shaped bottom portion, and wall portions formed on opposing two sides of the rectangular shape, it is desirable: that the through hole and/or cut-out portion are/is formed only in the bottom face.

In case where the jig for firing ceramics according to the present invention is configured by: a rectangular-shaped bottom portion; and pillar-shaped portions formed on four corners of the rectangular shape, it is desirable: that the through hole and/or cut-out portion are/is formed in the bottom face.

The jig for firing ceramics according to the present invention is preferably the jig for firing ceramics wherein said through hole and/or cut-out portion are/is formed in the bottom face of said jig for firing ceramics, and the area of the portion on the bottom face of said jig for firing ceramics in which said through hole and/or cut-out portion are/is formed occupies about 0.5% to about 60% of the area of said bottom face.

In the above-mentioned jig for firing ceramics, the area of the portion on the bottom face of said jig for firing ceramics in which said through hole and/or cut-out portion are/is formed more desirably occupies about 10% to about 40% of the area of said bottom face, and furthermore desirably occupies about 10% to about 30% of the area of said bottom face.

It is desirable that: the shape of the through hole of said jig for firing ceramics has a rectangular shape with R-portions formed on corner portions of the rectangular shape, a rectangular shape with C-chamfered faces formed on corner portions of the rectangular shape, a round shape, a rectangular shape, a triangular shape, a pentagonal shape or an elliptical shape.

The jig for firing ceramics desirably has a carbon-powder holding area at a portion of said bottom face.

Moreover, a manufacturing method for a porous ceramic body according to the present invention is a manufacturing method for a porous ceramic body in which, after a pillar-shaped ceramic formed body containing ceramic powder and a binder has been degreased, the pillar-shaped ceramic formed body is placed in a jig for firing and fired, comprising the step of: using jig for firing ceramics having a through hole and/or a cut-out portion formed in a portion thereof, by piling it up in multiple stages as said jig for firing.

In a manufacturing method for a porous ceramic body according to the present invention, a jig for firing ceramics is desirably used by piling it up in multiple stages, said jig for firing ceramics either: having a box shape with its upper face opened; being configured by a substantially rectangular-shaped bottom portion, and wall portions formed on opposing two sides of the rectangular shape; being configured by a rectangular-shaped bottom portion, and pillar-shaped portions formed on four corners of the rectangular shape; or having a flat plate shape.

In a manufacturing method for a porous ceramic body according to the present invention, in case where said jig for firing ceramics which has a flat plate shape is used, it is preferably used by piling it up in multiple stages through a square tubular base-supporting member.

In a manufacturing method for a porous ceramic body according to the present invention, preferably, said through hole and/or cut-out portion are/is formed in the bottom face of the jig for firing ceramics, and the area of the portion on the bottom face of said jig for firing ceramics in which said through hole and/or cut-out portion are/is formed occupies about 0.5% to about 60% of the area of said bottom face.

In a manufacturing method for a porous ceramic body according to the present invention, the area of the portion on the bottom face of said jig for firing ceramics in which said through hole and/or cut-out portion are/is formed desirably occupies about 10% to about 40% of the area of said bottom face and further desirably occupies about 10% to about 30% of the area of said bottom face.

Also, in the manufacturing method for a porous ceramic body according to the present invention, said jig for firing ceramics desirably has a carbon-powder holding area in the bottom face.

A porous ceramic body according to the present inventnion is manufactured in such a manner that, after a pillar-shaped ceramic formed body containing ceramic powder and a binder has been degreased, the degreased pillar-shaped ceramic formed body is placed in a jig for firing and fired, wherein sintering is conducted in condition that: said degreased ceramic formed body is placed in a jig for firing ceramics having a through hole and/or a cut-out portion formed in a portion thereof; and said jigs for firing ceramics on which said ceramic formed body is placed are piled up in multiple stages.

### BRIEF DESCRIPTIONS OF THE DRAWINGS

FIG. 1A is a plan view that schematically shows one example of a jig for firing ceramics according to the present invention, and FIG. 1B is a cross-sectional view taken along line A-A of the jig for firing ceramics shown in FIG. 1A.

FIG. 2A is a plan view that shows another example of the jig for firing ceramics of the present invention, and FIG. 2B is a cross-sectional view taken along line A-A of the jig for firing ceramics shown in FIG. 2A.

FIG. 3 is a plan view that shows still another example of the jig for firing ceramics of the present invention.

FIG. 4 is a plan view that shows still another example of the jig for firing ceramics of the present invention.

FIG. 5A is a plan view that shows still another example of the jig for firing ceramics of the present invention, FIG. 5B is a cross-sectional view taken along line A-A of the jig for firing ceramics shown in FIG. 5A.

FIG. 6A is a plan view that shows still another example of the jig for firing ceramics of the present invention, FIG. 6B is a cross-sectional view taken along line A-A of the jig for firing ceramics shown in FIG. 6A, and FIG. 6C is a cross-sectional view taken along line B-B of the jig for firing ceramics shown in FIG. 6A.

FIG. 7A is a plan view that shows still another example of the jig for firing ceramics of the present invention, FIG. 7B is a cross-sectional view taken along line A-A of the jig for firing ceramics shown in FIG. 7A, and FIG. 7C is a perspective view that schematically shows one example of a base-supporting portion to be used upon piling up the jig for firing ceramics in multiple stages.

FIG. 8A is a cross-sectional view that schematically shows one example of a firing method in which the jig for firing ceramics of the present invention is used, and FIG. 8B is a cross-sectional view that shows a state in which base-supporting members are used upon firing.

FIG. 9 is a perspective view that schematically shows a ceramic filter manufactured by using a porous ceramic body.

FIG. 10A is a perspective view that schematically shows a porous silicon carbide sintered body, and FIG. 10B is a cross-sectional view taken along line A-A of a porous silicon carbide sintered body shown in FIG. 10A.

FIG. 11A is a plan view that schematically shows a conventional jig for firing, and FIG. 11B is a front view that shows a state in which silicon carbide formed bodies are placed inside the jig for firing shown in FIG. 11A and piled up.

### DESCRIPTION OF THE EMBODIMENTS

The following description will first discuss a jig for firing ceramics according to the present invention. The jig for firing ceramics of the present invention is the jig for firing ceramics, which is used by being piled up in multiple stages upon firing a ceramic formed body, having a through hole and/or a cut-out portion formed in a portion thereof.

In other words, either of a through hole or a cut-out portion, or both of these are formed at a portion of the jig for firing ceramics of the present invention.

Referring to figures, the following description will respectively discuss a jig for firing ceramics in which only the through hole is formed, a jig for firing ceramics in which only the cut-out portion is formed and a jig for firing ceramics in which both of the through hole and the cut-out portion are formed.

Referring to figures, the jig for firing ceramics of the present invention will be explained.

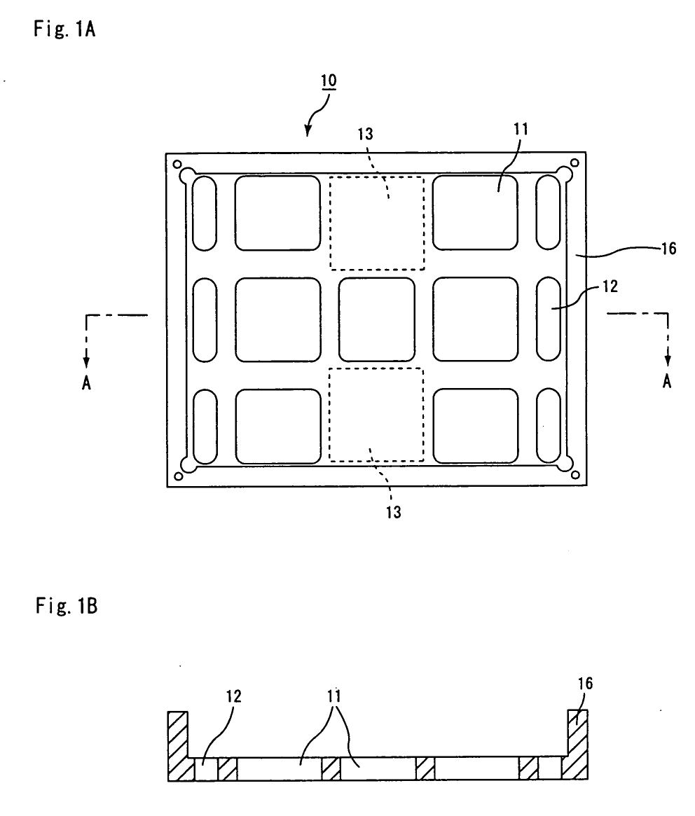

FIG. 1A is a plan view that schematically shows one example of a jig for firing ceramics of the present invention, and FIG. 1B is a cross-sectional view taken along line A-A of the jig for firing ceramics shown in FIG. 1A.

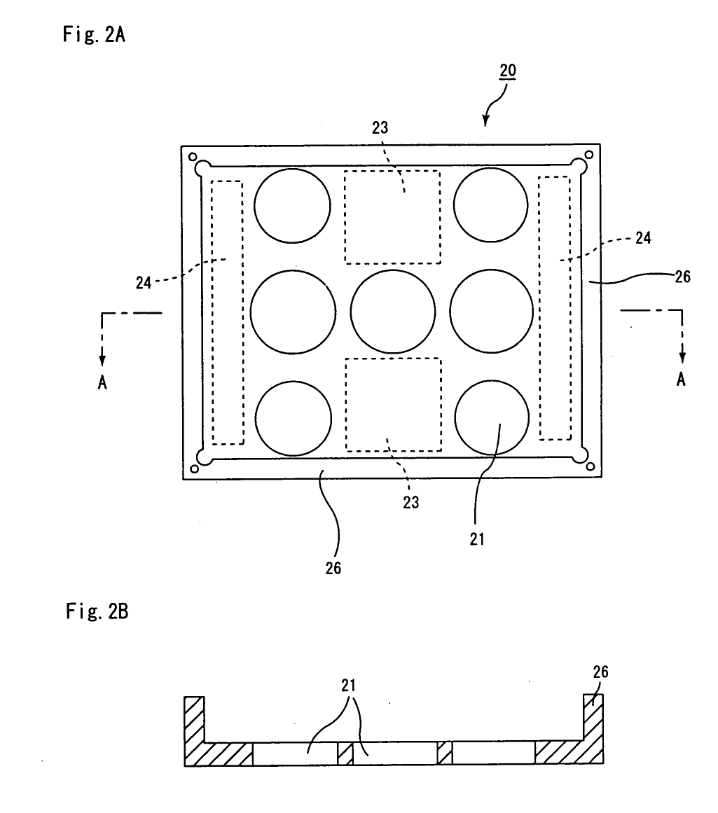

FIG. 2A is a plan view that shows another example of the jig for firing ceramics of the present invention, and FIG. 2 B is a cross-sectional view taken along line A-A of the jig for firing ceramics shown in FIG. 2A.

FIGS. 1A,B and 2A,B respectively show jig for firing ceramics in which only the through hole is formed.

The jig for firing ceramics 10 shown in FIGS. 1A,B have a box-shape with the upper face being open, and a plurality of through holes 11 and 12 are formed in the bottom face.

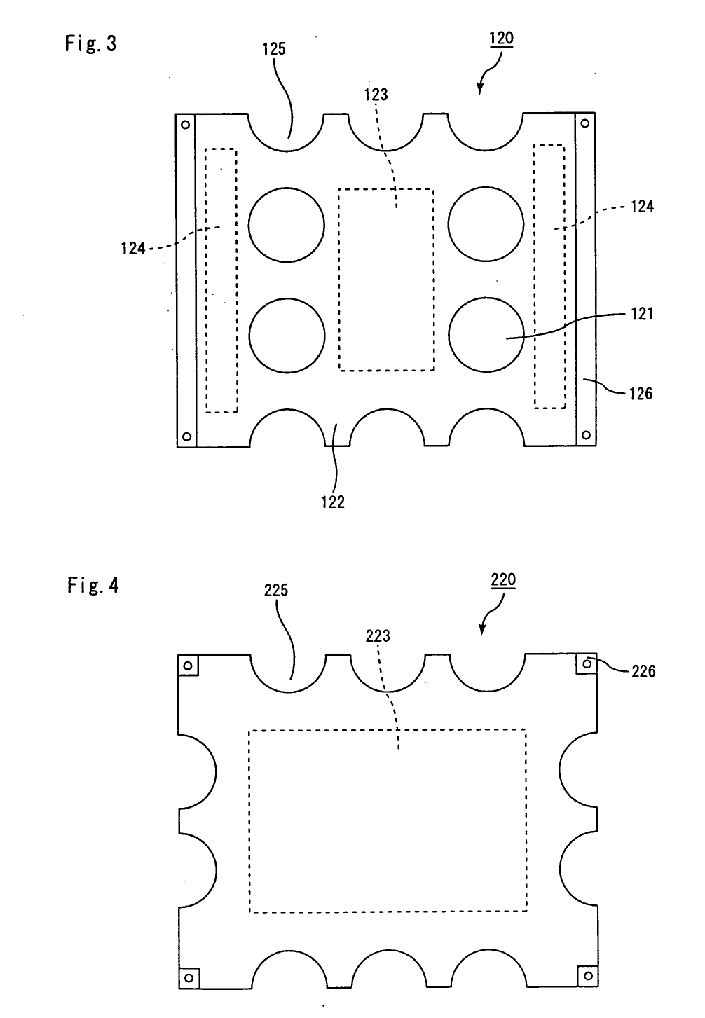

In this manner, since the plurality of through holes 11 and 12 are formed, a convection easily takes place inside each jig for firing ceramics 10 even when the jigs for firing ceramics are piled up in multiple stages and used, and an ambient atmospheric gas is allowed to flow inside the jigs for firing ceramics 10 that are piled up; thus, the ambient temperature on the periphery of each of ceramic formed bodies placed inside each of the jig for firing ceramics 10 is virtually equalized independent of positions of the respective jig for firing ceramics and positions at which they are placed inside each jig for firing ceramics, and the component concentrations (for example, component concentrations, such as SiC, SiO, Si and the like, in a silicon carbide formed body) in the ambient atmospheric gas on the periphery of each of ceramic formed bodies are also equalized so that each of the ceramic formed bodies can be fired under uniform conditions. Here, in general, upon piling up the jig for firing ceramics 10, a plate-shaped lid 33 (see FIG. 3) is placed on the uppermost jig for firing ceramics 10 so that dusts and the like are prevented from entering the inside of each jig for firing ceramics 10. Thus, the entire structure of the piled-up jig for firing ceramics is formed into a closed space so that the ambient atmosphere of the entire piled-up jig for firing ceramics can be equalized.

Here, in the jig for firing ceramics 10, the wall portion 16 of a side face is allowed to function as a base-supporting portion upon piling up the jig for firing ceramics in multiple stages.

With respect to the shape in the plan view of each through hole formed in the jig for firing ceramics of the present invention, not limited to a shape in which a rectangular shape with R-chamfered faces being formed on corner portions thereof as shown by through holes 11 and 12 in FIG. 1, the shape may be prepared as a round shape as indicated by a jig for firing ceramics 20 shown in FIG. 2. With respect to the other shapes of the through hole, for example, a rectangular shape with C-chamfered faces being formed on corner portions thereof (octagonal shape), a rectangular shape, a triangular shape, a hexagonal shape and an elliptical shape are proposed.

The jig for firing ceramics 20, shown in FIGS. 2A,B are the same as the jig for firing ceramics 10 shown in FIGS. 1A,B, except for the shape and position of each through hole 21 formed in the bottom face thereof.

Moreover, in the case where through holes are formed in the bottom face of the jig for firing ceramics as shown in FIGS. 1A,B and FIG. 2A, B, the area of the portion on which the through holes are formed is preferably set in a range of about 0.5% to about 60%, with respect to the bottom face area of the jig for firing ceramics.

In the case where the area of the portion on which the through holes are formed is about 0.5% or more and less than about 60%, it is possible to sufficiently obtain: strength in the jig for firing ceramics; and the effects of forming the through holes as described above.

Moreover, as will be described below, it is preferable to form a carbon-powder holding area at a portion on the bottom face.

The lower limit of the rate of the area of the portion at which the through holes are formed is preferably set to about 10%. The upper limit of the rate of the area of the portion at which the through holes are formed is preferably set to about 40%, more preferably, to about 30%.

Here, in the jig for firing ceramics of the present invention, the bottom face refers to a portion at which the ceramic formed body is placed, independent of whether or not a wall portion is formed at the side thereof.

The area on the bottom face refers to an area of a portion surrounded by an outer edge when the jig for firing ceramics is viewed from the bottom, and in the case where a cut-out portion is further formed, the area of the cut-out portion is also included in the area on the bottom face.

The formation position of the through holes is preferably at the bottom face of the jig for firing ceramic; however, not limited to the bottom face, the side face may be the formation position of the through holes in the case where the shape of the jig for firing ceramics is a box-shape as shown in FIG. 1A, B. Of course, through holes may be formed on both on the bottom face and the wall face.

The jig for firing ceramics of the present invention preferably has a carbon-powder holding area at a portion on the bottom face.

The reason for this structure, which will be described later in detail, is because upon firing a silicon carbide formed body, by spreading carbon powder all over the inside of the jig for firing ceramics together with the silicon carbide formed body, it becomes possible to prevent occurrence of dispersions in the bending strength and occurrence of cracks and the like in the silicon carbide sintered body to be manufactured.

Here, the carbon-powder holding area corresponds to each of areas 13, 23 and 24 surrounded by broken lines in the jig for firing ceramics, for example, shown in FIGS. 1A,B and 2A,B.

FIGS. 3, 4 are plan views that show another example of the jig for firing ceramics of the present invention. FIG. 3 shows a jig for firing ceramics in which through holes and cut-out portions are formed, and FIG. 4 shows a jig for firing ceramics in which only cut-out portions are formed.

In the jig for firing ceramics 120 shown in FIG. 3, through holes 121 and cut-out portions 125 are formed on the bottom face thereof.

In the case where the cut-out portions 125 are formed together with the through holes 121 in this structure, in the same manner as the jig for firing ceramics 10, a convection easily takes place inside each jig for firing ceramics when the jigs for firing ceramics are piled up in multiple stages and used, and an ambient atmospheric gas is allowed to flow inside the jigs for firing ceramics 120 that are piled up; thus, the ambient temperature on the periphery of each of ceramic formed bodies placed inside each of the jig for firing ceramics 120 is virtually equalized independent of positions of the respective jig for firing ceramics and positions at which they are placed inside each jig for firing ceramics, and the component concentrations (for example, component concentrations, such as SiC, SiO, Si and the like, in a silicon carbide formed body) in the ambient atmospheric gas on the periphery of each of ceramic formed bodies are also equalized so that each of the ceramic formed bodies can be fired under uniform conditions.

Moreover, the jig for firing ceramics 120 is configured by: a bottom portion 122 having a substantially rectangular-shaped bottom portion 122; and wall portions 126 formed on opposing two sides of the rectangular shape. Thus, the wall portion 126 is allowed to function as a base-supporting portion upon piling up the jig for firing ceramics in multiple stages.

Here, areas 123 and 124 surrounded by broken lines correspond to carbon-powder holding areas.

In a jig for firing ceramics 220 shown in FIG. 4, cut-out portions 225 are formed on respective sides of the bottom face.

In the case where only the cut-out portions 225 are formed as described above also, in the same manner as the jig for firing ceramics 10, a convection easily takes place inside each jig for firing ceramics 10 when the jigs for firing ceramics are piled up in multiple stages and used, and an ambient atmospheric gas is allowed to flow inside the jigs for firing ceramics 220 that are piled up; thus, the ambient temperature on the periphery of each of ceramic formed bodies placed inside each of the jig for firing ceramics 220 is virtually equalized independent of positions of the respective jig for firing ceramics and positions at which they are placed inside each jig for firing ceramics, and the component concentrations (for example, component concentrations, such as SiC, SiO and Si, in a silicon carbide formed body) in the ambient atmospheric gas on the periphery of each of ceramic formed bodies are also equalized so that each of the ceramic formed bodies can be fired under uniform conditions.

Moreover, in the jig for firing ceramics 220, pillar members 226 are placed on the respective four corners of the bottom face, and these wall portions 226 are allowed to function as base-supporting portions upon piling up the jig for firing ceramics in multiple stages.

Here, an area 223 surrounded by a broken line occupies a carbon-powder holding area.

As shown in FIGS. 1 to 4, in the jig for firing ceramics of the present invention, only the through holes may be formed on a portion of the bottom face, or both of the through holes and the cut-out portions may be formed thereon, or only the cut-out portions may be formed thereon.

With respect to the shape in its plan view of each cut-out portion formed in the jig for firing ceramics of the present invention, not limited to a semi-circular shape as shown in FIGS. 3 and 4, any desired shapes, such as a semi-elliptical shape, a rectangular shape, a polygonal shape and the like, may be used.

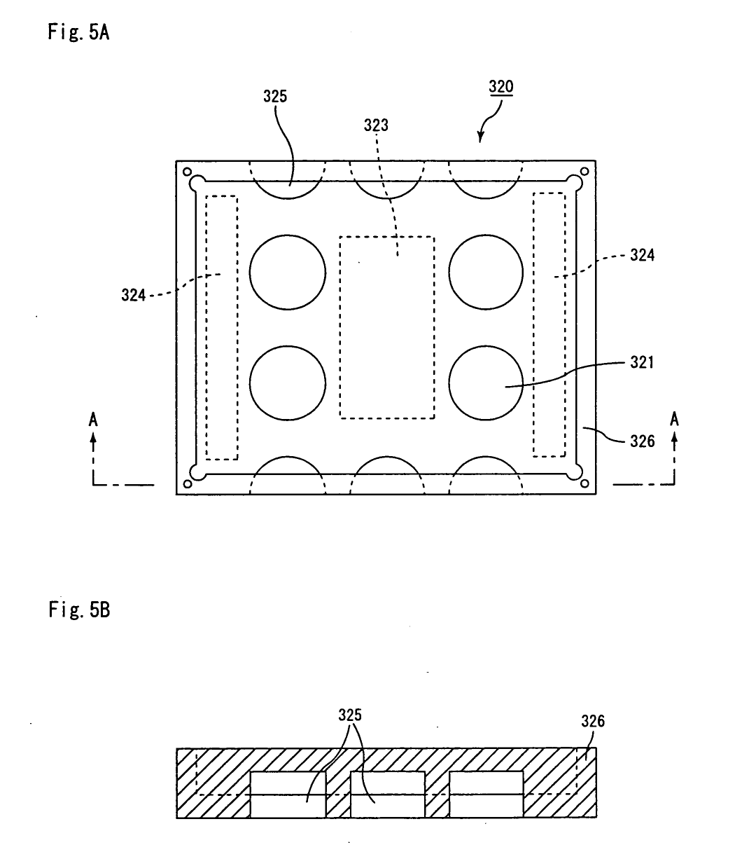

FIG. 5A is a plan view that shows still another example of the jig for firing ceramics of the present invention, and FIG. 5B is a cross-sectional view taken along line A-A of the jig for firing ceramics shown in FIG. 5A.

FIGS. 5A,B shows a jig for firing ceramics in which through holes and cut-out portions are formed.

The jig for firing ceramics 320 shown in FIGS. 5A,B have a box-shape with the upper face being open, and a plurality of through holes 321 are formed in the bottom face, and a plurality of cut-out portions 325, each of which is connected to the bottom face and a side face, are formed thereon.

In the case where the cut-out portions 325 are formed together with the through holes 321 as described above also, in the same manner as the jig for firing ceramics 10, a convection easily takes place inside each jig for firing ceramics when the jigs for firing ceramics are piled up in multiple stages and used, and an ambient atmospheric gas is allowed to flow inside the jigs for firing ceramics 320 that are piled up; thus, the ambient temperature on the periphery of each of ceramic formed bodies placed inside each of the jig for firing ceramics 320 is virtually equalized independent of positions of the respective jig for firing ceramics and positions at which they are placed inside each jig for firing ceramics, and the component concentrations (for example, concentrations of components, such as SiC, SiO, Si and the like, in a silicon carbide formed body) in the ambient atmospheric gas on the periphery of each of ceramic formed bodies are also equalized so that each of the ceramic formed bodies can be fired under uniform conditions.

Moreover, in the jig for firing ceramics 320, the wall portion 326 of the side face is allowed to function as a base-supporting portion upon piling up the jig for firing ceramics in multiple stages.

Here, areas 323 and 324 surrounded by broken lines correspond to carbon-powder holding areas.

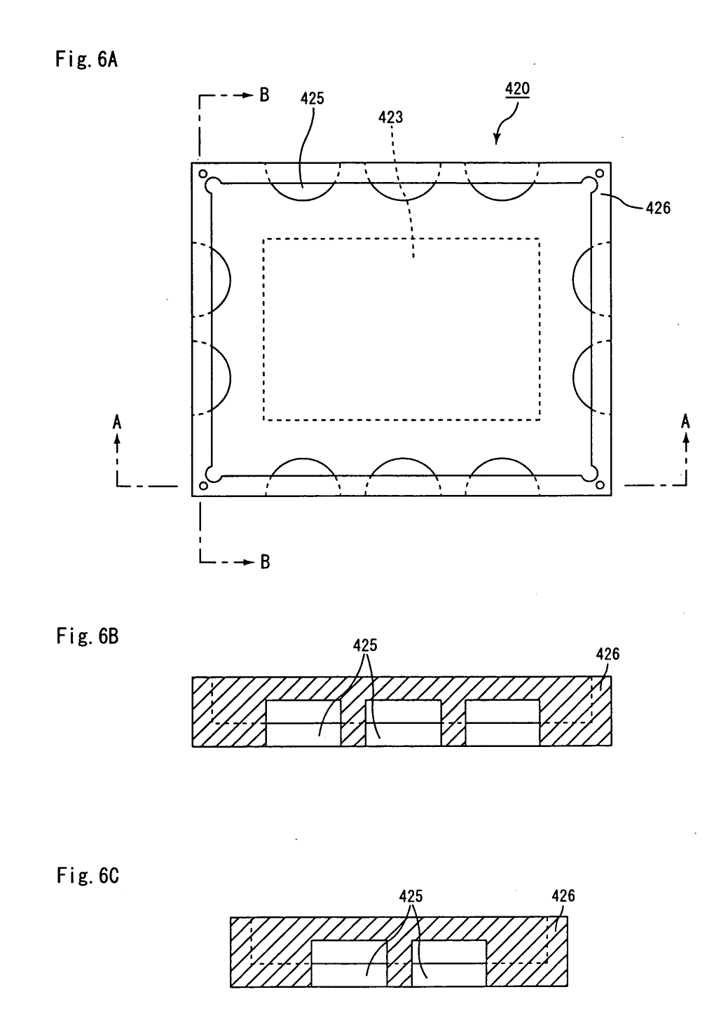

FIG. 6A is a plan view that shows still another example of the jig for firing ceramics of the present invention; FIG. 6B is a cross-sectional view taken along line A-A of the jig for firing ceramics shown in FIG. 6A; and FIG. 6C is a cross-sectional view taken along line B-B of the jig for firing ceramics shown in FIG. 6A.

FIG. 6 shows a jig for firing ceramics in which only the cut-out portions are formed.

The jig for firing ceramics 420 shown in FIGS. 6A to 6C have a box-shape with the upper face being open, and a plurality of cut-out portions 425 each of which is connected to the bottom face and side face are formed therein.

In the case where the cut-out portions 425 are formed as described above also, in the same manner as the jig for firing ceramics 10, a convection easily takes place inside each jig for firing ceramics when the jigs for firing ceramics are piled up in multiple stages and used, and an ambient atmospheric gas is allowed to flow inside the jigs for firing ceramics 420 that are piled up; thus, the ambient temperature on the periphery of each of ceramic formed bodies placed inside each of the jig for firing ceramics 420 is virtually equalized independent of positions of the respective jig for firing ceramics and positions at which they are placed inside each jig for firing ceramics, and the component concentrations (for example, concentrations of components, such as SiC, SiO, Si and the like, in a silicon carbide formed body) in the ambient atmospheric gas on the periphery of each of ceramic formed bodies are also equalized so that each of the ceramic formed bodies can be fired under uniform conditions.

Moreover, in the jig for firing ceramics 420, the wall portion 426 of the side face is allowed to function as a base-supporting portion upon piling up the jig for firing ceramics in multiple stages.

Here, areas 423 and 424 surrounded by broken lines correspond to carbon-powder holding areas.

In the jig for firing ceramics in which the cut-out portions each of which is connected to the bottom face and side face are formed as shown in FIGS. 5 A,B and 6 A to C, of course, the shape in the plan view of the cut-out portion formed in the bottom face is not particularly limited to a semi-circular shape, and the shape in the front view and the shape in the side view of the cut-out portion formed on the side face are not particularly limited to a rectangular shape as shown in the figures, and may be formed into shapes such as a semi-circular shape, a semi-elliptical shape, a polygonal shape and the like.

Moreover, in the case where the cut-out portions are formed in the box-shaped jig for firing ceramics, each of the cut-out portions is not particularly limited to a cut-out portion which is connected to the bottom face and side face as shown in FIGS. 5 A,B and 6 A to C, and, for example, the cut-out portion may be formed only on the bottom face, with no cut-out portion being formed on the side face.

Furthermore, in the box-shaped jig for firing ceramics, a through hole and/or a cut-out portion may be formed in the side face in a separate manner from the through hole and the cut-out portion formed in the bottom face.

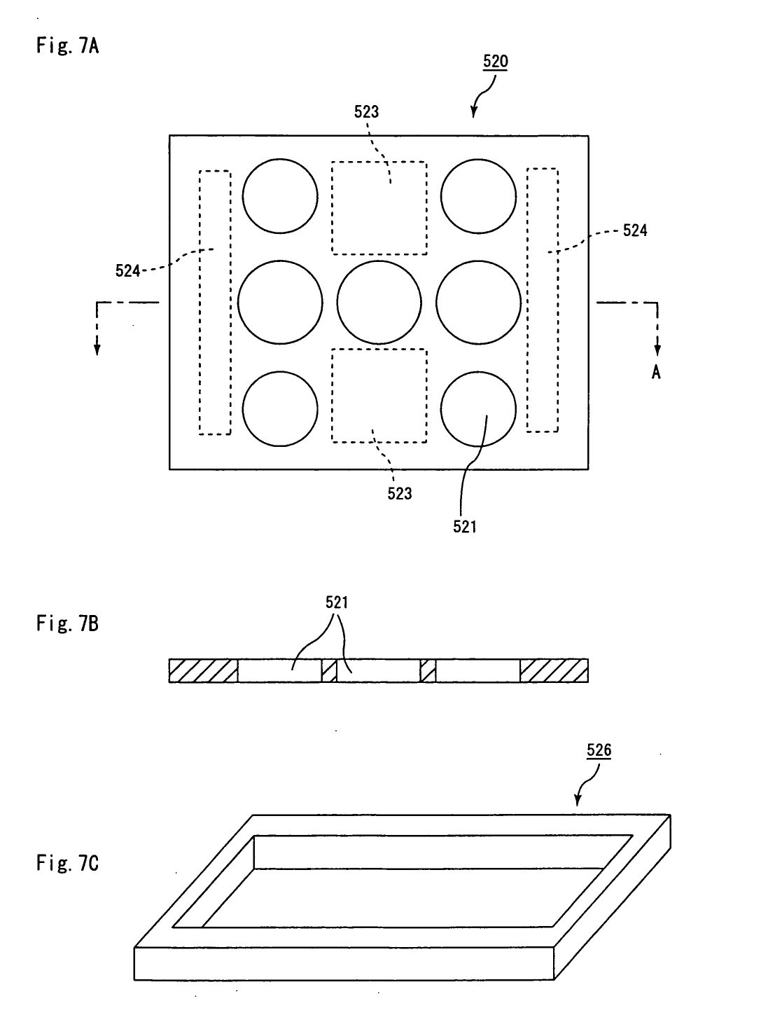

FIG. 7A is a plan view that shows still another example of the jig for firing ceramics of the present invention; FIG. 7B is a cross-sectional view taken along line A-A of the jig for firing ceramics shown in FIG. 7A; and FIG. 7C is a perspective view that schematically shows one example of a base-supporting portion that is used upon piling up the jig for firing ceramics in multiple stages.

FIGS. 7 A,B show a flat jig for firing ceramics that is formed by only the bottom face without a wall portion.

The jig for firing ceramics 520 shown in FIGS. 7 A,B has a flat plate shape without a wall portion, and in the same manner as the jig for firing ceramics 20 shown in FIGS. 2 A,B, a plurality of through holes 521 are formed in the bottom face.

In the case of the jig for firing ceramics 520 also, since the through holes 521 are formed in this manner, a convection easily takes place inside each jig for firing ceramics 520 even when the jigs for firing ceramics are piled up in multiple stages and used, in the same manner as the jig for firing ceramics 10, and an ambient atmospheric gas is allowed to flow inside the jigs for firing ceramics 520 that are piled up; thus, the ambient temperature on the periphery of each of ceramic formed bodies placed inside each of the jig for firing ceramics 520 is virtually equalized independent of positions of the respective jig for firing ceramics and positions at which they are placed inside each jig for firing ceramics, and the component concentrations (for example, component concentrations, such as SiC, SiO, Si and the like, in a silicon carbide formed body) in the ambient atmospheric gas on the periphery of each of ceramic formed bodies are also equalized so that each of the ceramic formed bodies can be fired under uniform conditions.

Here, in FIG. 7A, B, areas 523 and 524 surrounded by broken lines correspond to carbon-powder holding areas.

In the case where the jigs for firing ceramics 520 are piled up in multiple stages and used, since the jig for firing ceramics 520 is not provided with a wall portion that functions as a base-supporting portion, the base-supporting portion needs to be prepared in a separate manner.

More specifically, for example, a square tubular base-supporting portion 526 as shown in FIG. 7C is interpolated between the jigs for firing ceramics 520 so that the flat-plate-shaped jigs for firing ceramics 520 can be piled up in multiple stages. With respect to the base-supporting portion 526 of this type, a through hole may be formed therein, or a cut-out portion may be formed at a portion thereof in a degree so as not to intervene with the piling-up process of the jig for firing ceramics.

Here, the base-supporting portion 526 is prepared as a tubular base-supporting portion; however, the base-supporting portion to be used upon piling up the flat-plate-shaped jig for firing ceramics is not necessarily limited to such a shape, and, for example, a plurality of base-supporting portions having shapes, such as a flat-plate shape, a rectangular pillar shape, a cylindrical shape and the like, may be used, and these base-supporting portions may be placed on the periphery of the jig for firing ceramics 520 so that the jig for firing ceramics 520 may be superposed one after another.

Moreover, in the jig for firing ceramics shown in FIGS. 3 to 7 also, the rate of the area occupied by the portion in which through holes and/or cut-out portions are/is formed with respect to the bottom face of the jig for firing ceramics is preferably set in the range described earlier.

As described above, in the jig for firing ceramics of the present invention, since a through hole and/or a cut-out portion are/is formed at a portion thereof, the above-mentioned effects are exerted.

Moreover, as shown in FIGS. 1 to 6, in the jig for firing ceramics of the present invention, the portions that function as the base-supporting portions upon piling up the jig for firing ceramics in multiple stages may be formed on the entire sides of the bottom face, or may be formed on a portion of each side. However, from the viewpoint of preventing the occurrence of warping upon use, the portion that functions as the base-supporting portion is preferably formed on the entire sides of the bottom face.

In the case of the flat-plate-shaped jig for firing ceramics as shown in FIGS. 7 A,B, base-supporting portions are prepared in a separate manner, and the jig for firing ceramics can be piled up by using these.

With respect to the material for the jig for firing ceramics, for example, carbon materials and the like may be used.

Moreover, the carbon material may be prepared as porous carbon having pores.

The reason why carbon powder is spread all over the bottom face of the jig for firing ceramics is explained as follows:

In a conventional manufacturing method for a porous silicon carbide sintered body, a silicon carbide formed body that has been subjected to a degreasing process contains about 3% of SiO₂ in the silicon carbide formed body owing to manufacturing conditions, degreasing conditions and the like of the material. However, in the next firing process, a heating process is carried out at extremely high temperatures such as 2000° C. or more at the highest temperature; thus, SiO₂ in the silicon carbide formed body is sublimated and discharged from the silicon carbide formed body. Moreover, carbon is present in the silicon carbide formed body although the amount thereof is very small, and since the substance that forms the jigs for firing to be used in the firing process and the base-supporting members on which the silicon carbide formed body is placed is carbon, a reaction as indicated by the following reaction formula (1) proceeds between the carbon and SiO₂ to generate SiO gas.
SiO₂+C→SiO+CO (1)
Moreover, a reaction as indicated by the following reaction formula (2) proceeds between the SiO gas thus generated and carbon that is present in the silicon carbide formed body as well as carbon forming the jigs for firing:
SiO+2C→SiC+CO (2)
In other words, as the firing process progresses, the carbon that is present in the silicon carbide formed body and the carbon forming the jigs for firing are gradually consumed by sublimated SiO₂ and SiO gas.

However, as described earlier, the amount of carbon that is present in the silicon carbide formed body that has been subjected to a degreasing process is very small, and soon consumed and eliminated through the reactions indicated by the above-mentioned reaction formulas (1) and (2). Moreover, the carbon forming the jigs for firing and the like is capable of serving as a good supplying source of carbon in the reactions indicated by the reaction formulas (1) and (2); however, when the surface portion of the jigs for firing has been formed into SiC, the jigs for firing can no longer supply carbon to the reactions indicated by the above-mentioned reaction formulas (1) and (2).

In other words, as the firing process progresses, the amount of carbon to be supplied to the reactions indicated by the above-mentioned reaction formulas (1) and (2) decreases, and in contrast, the concentration of SiO gas increases. As a result, a reaction as indicated by the following reaction formula (3) progresses between the high concentration SiO gas and SiC forming the most portion of the silicon carbide formed body:
SiO+SiC→2Si+CO (3)
For this reason, Si is contained in the silicon carbide formed body during the firing process; thus sintering is difficult to progresses in the silicon carbide formed body of this type. Consequently, although the silicon carbide particles themselves are allowed to grow grains, so-called necking, that is, combination between the silicon carbide particles having grown grains, is not sufficiently formed to cause dispersions in the strength of the porous silicon carbide sintered body to be manufactured and the subsequent degradation in the strength.

Moreover, when the surfaces of the jigs for firing have been formed into SiC due to the reaction indicated by the above-mentioned reaction formula (2), these members become too hard, with irregularities being formed on the surfaces thereof. For this reason, portions at which the silicon carbide formed body is made in contact with the jig for firing during the firing process and portions at which the silicon carbide formed body comes into contact with the jig for firing that has been converted into SiC due to vibration or the like during the firing process tend to have cracks. In order to prevent this phenomenon, the present invention prepares an area for holding carbon powder at a portion on the bottom face of the jig for firing ceramics.

The jig for firing ceramics having the area for holding carbon powder at a portion of the base surface is preferably used for manufacturing a porous ceramic body made from carbide ceramics, and more preferably used for manufacturing a porous ceramic body made from silicon carbide. In the case where it is used for manufacturing a porous ceramic body made from a material such as nitride ceramics, oxide ceramics and the like, the area used for holding carbon powder may be prepared, or does not have to be prepared.

Moreover, in the case where it is used for manufacturing nitride ceramics and oxide ceramics, in place of carbon powder, inorganic powder, which makes ambient atmospheric component concentrations on the periphery of the ceramic formed body uniform, may be used.

According to the jig for firing ceramics of the present invention, a through hole and/or a cut-out portion are/is formed on a portion thereof; therefore, even in the case where, upon firing a ceramic formed body by using the jig for firing ceramics, the jigs for firing ceramics, which are piled up in multiple stages, are used, an ambient atmospheric gas is allowed to flow inside the jigs for firing ceramics piled up in multiple stages so that the ambient temperature on the periphery of the ceramic formed body is equalized, and component concentrations in the ambient atmospheric gas are also equalized. In particular, in the case where, upon manufacturing a silicon carbide sintered body, this jig for firing ceramics is used, an ambient atmospheric gas is allowed to flow inside the jigs for firing ceramics piled up in multiple stages so that the ambient atmosphere on the periphery of the ceramic formed body is equalized, and concentrations of components, such as SiC, SiO, Si and the like, in the ambient atmosphere are also equalized. Consequently, a number of ceramic formed bodies are sintered under uniform conditions so that it becomes possible to obtain ceramic filters that exert uniform characteristics when used as filters.

The following description will discuss a manufacturing method for the porous ceramic body of the present invention.

The manufacturing method for a porous ceramic body of the present invention is a method of manufacturing a porous ceramic body in which, after a pillar-shaped ceramic formed body containing ceramic powder and a binder has been degreased, the pillar-shaped ceramic formed body is placed in a jig for firing and fired, comprising the step of: using a jig for firing ceramics having a through hole and/or a cut-out portion formed in a portion thereof, by piling it up in multiple stages as said jig for firing.

In the above-mentioned manufacturing method for a porous ceramic body, said through hole and/or cut-out portion are/is formed in the bottom face of the jig for firing ceramics, and the area of the portion on the bottom face of said jig for firing ceramics in which said through hole and/or cut-out portion are/is formed occupies about 0.5% to about 60% of the area of said bottom face.

Moreover, in the manufacturing method for a porous ceramic body, the jig for firing ceramics preferably has a carbon-powder holding area in the bottom face.

In the manufacturing method for a porous ceramic body of the present invention, the above-mentioned jig for firing ceramics of the present invention may be used as a jig for firing ceramics.

The following description will discuss the manufacturing method for a porous ceramic body of the present invention, by exemplifying a case in which a porous ceramic body is manufactured by using a silicon carbide formed body as a ceramic formed body.

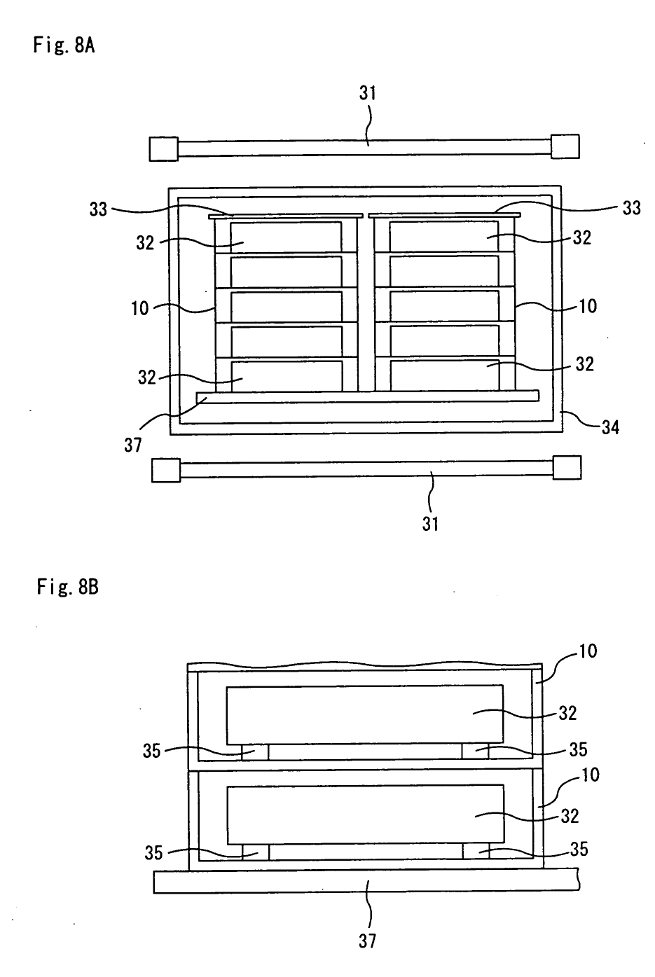

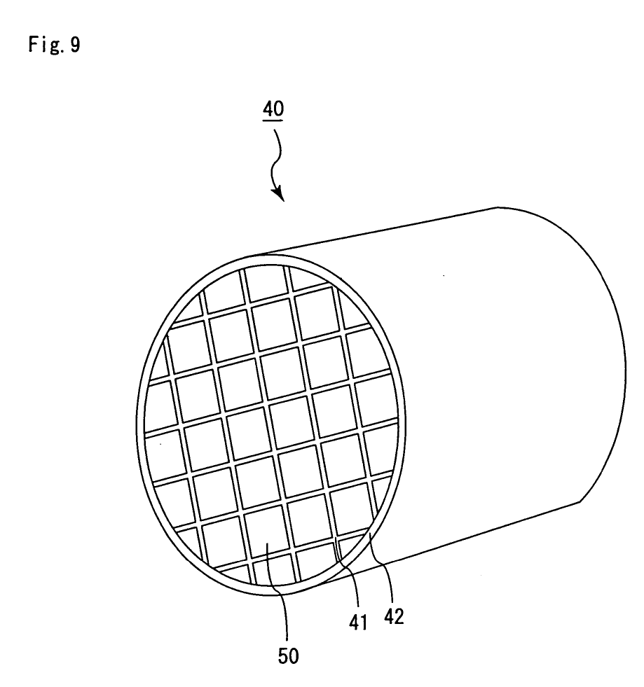

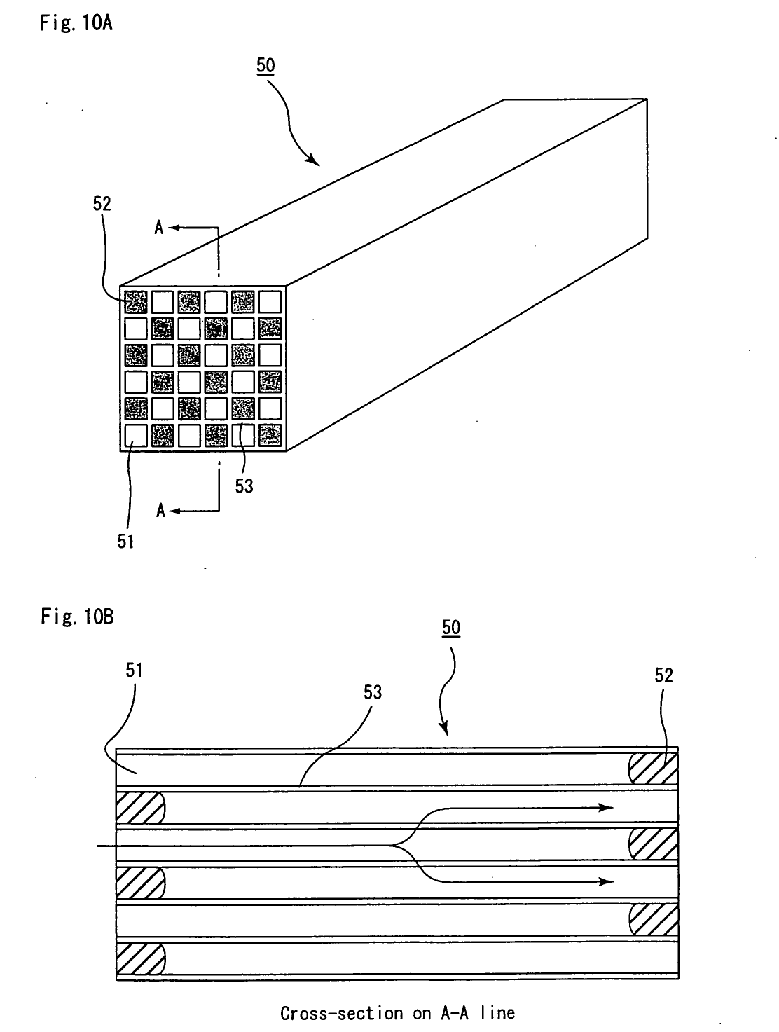

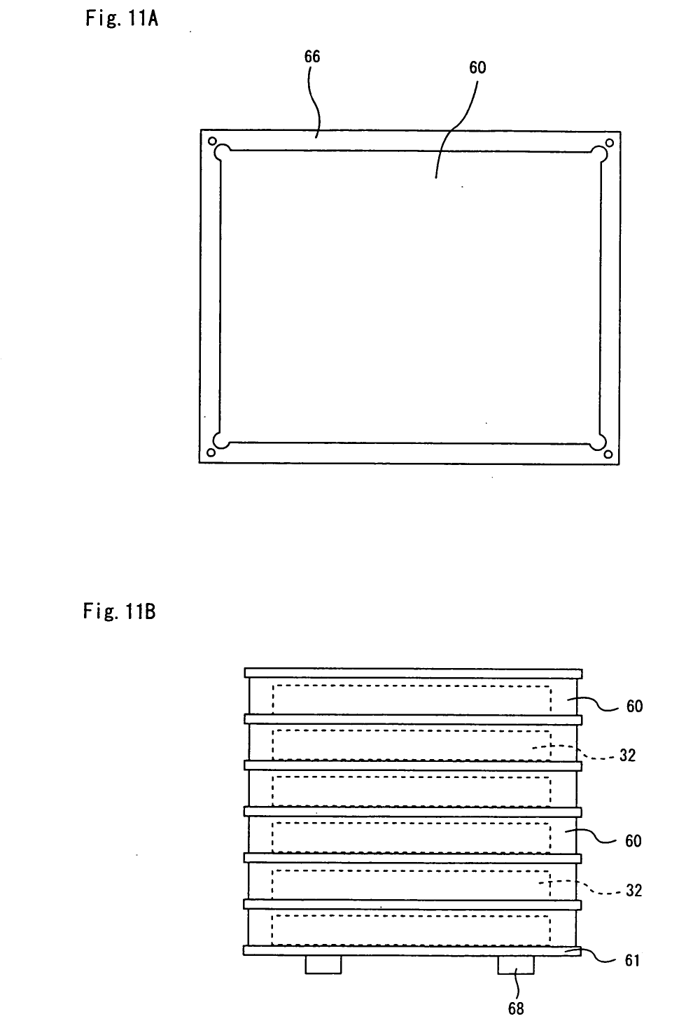

FIG. 8A is a front view that shows a state in which jigs for firing ceramics, shown in FIGS. 1A,B, which have been piled up in multiple stages, are transported into a firing furnace, and FIG. 8B is a front view that shows a state in which silicon carbide formed bodies are piled up through base-supporting members.

In the manufacturing method for the porous ceramic body of the present invention, first, a pillar-shaped silicon carbide formed body containing silicon carbide powder and a binder is formed. Here, if necessary, metal silicon may be added thereto so as to be set in a range from about 0 to about 45% by weight with respect to the entire weight.

With respect to the structure of the silicon carbide formed body, not particularly limited, for example, as explained in the Background of the Invention, a pillar-shaped formed body in which a number of through holes are placed in parallel to one another in the length direction with a partition wall interpolated in between and a pillar-shaped formed body which contains a number of pores communicated with one another formed therein may be used. Moreover, with respect to the shape thereof, not particularly limited, any desired shape, such as a cylindrical shape, an elliptical cylindrical shape, a rectangular pillar shape and the like, may be used. Here, in the following description, a pillar-shaped formed body in which a number of through holes are placed in parallel to one another in the length direction with a partition wall interpolated in between is used as the silicon carbide formed body.

With respect to the particle size of silicon carbide powder, although not particularly limited, those which are less susceptible to shrinkage in the succeeding firing process are preferably used, and for example, mixed powder, prepared by combining 100 parts by weight of powder having an average particle size from about 0.3 μm to about 50 μm with about 5 parts by weight to about 65 parts by weight of powder having an average particle size from about 0.1 μm to about 1.0 μm, is preferably used.

With respect to the above-mentioned binder, not particularly limited, examples thereof include: methylcellulose, carboxy methylcellulose, hydroxy ethylcellulose, polyethylene glycol, phenolic resin, epoxy resin and the like.

In general, the blended amount of the above-mentioned binder is preferably set to approximately about 1 parts by weight to about 10 parts by weight with respect to 100 parts by weight of the silicon carbide powder.

With respect to the dispersant solution, not particularly limited, examples thereof include: an organic solvent such as benzene; alcohol such as methanol; water and the like.

An appropriate amount of the above-mentioned dispersant solution is mixed therein so that the viscosity of the mixed composition is set within a fixed range.

After these silicon carbide powder, binder, dispersant solution and the like have been mixed by using an attritor or the like, the resulting mixture is sufficiently kneaded by using a kneader or the like, and then extrusion-formed and dried to manufacture a pillar-shaped silicon carbide formed body containing the silicon carbide powder and the binder.

Thereafter, the silicon carbide formed body manufactured in the above-mentioned process is subjected to a degreasing process.

In this degreasing process of the silicon carbide formed body, normally, after the silicon carbide formed body has been placed in the jig for firing ceramics of the present invention, the jig for firing ceramics is transported to a degreasing furnace, and heated to about 400° C. to about 650° C. in an oxygen-containing atmosphere.

Thus, the binder and the like are volatilized and decomposed to be eliminated so that virtually only the silicon carbide powder remains.

Upon placing the silicon carbide formed body in the jig for firing ceramics, base-supporting members 35 may be placed of the bottom face of the jig for firing ceramics 10 so as to support the silicon carbide formed body with a gap from the bottom face, as shown in FIG. 8A.

Here, the base-supporting members may be integrally formed with the jig for firing ceramics. By placing the base-supporting members, it becomes possible to prevent the degreased body and the sintered body of the silicon carbide formed body from sticking to the bottom face of the jig for firing ceramics to cause cracks and the like.

In the firing process, the degreased silicon carbide formed body 32 is placed in a jig for firing ceramics 10 of the present invention in which through holes 11 and 12 are formed in the bottom face thereof, as shown in FIG. 8A, and the jigs for firing ceramics 10 on which the silicon carbide formed bodies 32 are placed are piled up in a plurality of stages to form a piled-up body, and a lid 33 is placed on the uppermost portion. The piled-up body is then heated by a heater 31 so that the silicon carbide formed bodies 32 are fired. In this firing process, the degreased silicon carbide formed bodies 32 are heated at about 1400° C. to about 2000° C. in an inert gas atmosphere, such as nitrogen, argon and the like, so that the silicon carbide powder is sintered to manufacture a porous silicon carbide sintered body.

Since the silicon carbide formed body after the degreasing process is poor in the mechanical strength and easily broken, the jig for firing ceramics 10 is preferably designed so as to compatibly serve as a degreasing jig. Thus, after the degreasing process, the jig for firing ceramics 10 compatibly serving as the degreasing jig is preferably piled up in a plurality of stages, and used for the firing process.

In the present invention, for example, the piled-up body is placed on a supporting base 37, and the piled-up body is heated by heaters 31 attached to the upper and lower potions of a muffle 34 while being transported through the muffle 34; thus, a continuous firing method may be used. Here, a through hole may be formed in the supporting base 37, or does not have to be formed therein; however, it is preferable to prepare the through hole.

In the case where a through hole is formed in the supporting base with the through hole formed in the supporting base being allowed to communicate with a through hole formed in the bottom face of the jig for firing ceramics, an ambient atmospheric gas is allowed to easily flow inside the jig for firing ceramics; thus, the temperature of the ambient atmosphere on the periphery of the ceramic formed body placed inside the jig for firing ceramics is made more uniform, and concentrations of components in the ambient atmosphere, such as SiC, SiO, Si an the like, on the periphery of the ceramic formed body are also made more uniform so that each of the ceramic formed bodies can be fired under uniform conditions.

Moreover, one set of jigs for firing ceramics piled up in multiple stages may be placed on the supporting base 37, or two sets thereof may be placed as shown in FIGS. 8 A,B, or three or more sets thereof may be placed thereon.

Since the base-supporting members 35 to be placed on the jig for firing ceramics 10 require sufficient heat resistance so as to withstand high temperatures at the time of firing, a ceramic material having such heat resistance is preferably used for the material thereof.

With respect to the ceramic material, those having a comparatively high heat conductivity are preferably used, and examples thereof include carbon, silicon carbide, aluminum nitride, silicon nitride and the like.

In the series of processes from the degreasing process to the firing process, as described earlier, the silicon carbide formed body, placed on the jig for firing ceramics through the base-supporting members, as it is, is preferably subjected to the degreasing process and the firing process. Thus, the degreasing process and the firing process can be carried out efficiently, and it becomes possible to prevent the silicon carbide formed body from being damaged in a replacing operation and the like.

In this manner, by using the manufacturing method for a porous ceramic body of the present invention, the inside of the silicon carbide formed body can be heated to a virtually uniform temperature so that dispersions in the average pore diameter in the sintered porous silicon carbide sintered body can be made small and the porous silicon carbide sintered body having virtually uniform bending strength can be obtained.

Moreover, even when the firing process is carried out on silicon carbide formed bodies piled up in a plurality of stages, the dispersions in temperature in the respective stages can be made smaller so that it is possible to manufacture porous silicon carbide sintered bodies having a fixed average pore diameter and bending strength stably.

In the above-mentioned embodiments, explanations have been given by exemplifying a case in which a porous silicon carbide sintered body is manufactured by firing a silicon carbide formed body; however, with respect to the ceramic material forming the porous ceramic body to be manufactured, not particularly limited to silicon carbide, examples thereof include: nitride ceramics, such as aluminum nitride, silicon nitride, boron nitride, titanium nitride and the like; carbide ceramics, such as zirconium carbide, titanium carbide, tantalum carbide, tungsten carbide and the like; and oxide ceramics, such as alumina, zirconia, cordierite, mullite, silica and the like. Moreover, the porous ceramic body may be prepared as a material made from two or more materials, such as a composite between silica and silicon carbide, and aluminum titanate. Here, the pore diameter of these porous ceramic bodies is preferably set in a range from about 5 μm to about 50 μm, and the porosity thereof is preferably set in a range from about 30% to about 70%.

With respect to the use of the resulting porous ceramic body, not particularly limited, the porous ceramic body may be used for various applications, and, for example, it is used for a member and the like that constitute a ceramic filter as shown in FIG. 9.

Moreover, according to the manufacturing method for a porous ceramic body of the present invention, since the jig for firing ceramics in which a through hole and/or a cut-out portion are/is formed at a portion thereof is used so as to carry out a firing process on a ceramic formed body, a plurality of ceramic formed bodies can be fired under uniform conditions so that it becomes possible to obtain a porous ceramic body that exert uniform characteristics when used as filters.

According to the porous ceramic body according to the present invention, since firing of the ceramic formed body is conducted by using a ceramic firing jig at the portion of which a through hole and/or a cut-out portion are/is formed, the obtained porous ceramic body exhibits uniform characteristics when used as filters.

### EXAMPLES

The following description will discuss specific examples; however, the present invention is not intended to be limited only by these examples.

### Example 1

(1) Powder of α-type silicon carbide having an average particle size of 10 μm (60% by weight) and powder of α-type silicon carbide having an average particle size of 0.5 μm (40% by weight) were wet-mixed, and 5 parts by weight of an organic binder (methyl cellulose) and 10 parts by weight of water were added to 100 parts by weight of the resulting mixture and kneaded to obtain a mixed composition. Next, after a slight amount of a plasticizer and a lubricant had been added and kneaded therein, the resulting mixture was extrusion-formed so that a silicon carbide formed body was manufactured.

(2) Next, after the above-mentioned silicon carbide formed body had been dried at 100° C. for 3 minutes by using a micro-wave drier, this was further dried at 110° C. for 20 minutes by using a hot air drier. After the dried silicon carbide formed body had been cut, the through holes were sealed with a sealing paste(plug) made from silicon carbide.

(3) Successively, by using each jig for firing ceramics which was made from carbon (DSG-332; made by SEC Co., Ltd.) and had through holes formed therein as shown in FIG. 1, ten dried silicon carbide formed bodies 32 were placed therein through base-supporting members made from carbon. Then, these jigs for firing ceramics were piled up in five stages, and a plate-shaped lid was placed on the uppermost portion thereof. Two rows of piled-up bodies of this type were placed on a supporting base 17. Here, the area of portions in which the through holes were formed on the bottom face of the jig for firing ceramics occupied 0.5% of the area on the bottom face of the jig for firing ceramics.

(4) Next, the jig for firing ceramics on which the silicon carbide formed bodies were placed were transported into a continuous degreasing furnace so that they were heated at 500° C. in a mixed gas atmosphere of air having an oxygen concentration of 8% and nitrogen so as to carry out a degreasing process; thus, silicon carbide degreased bodies were manufactured.

With the silicon carbide degreased bodies being placed on the jig for firing ceramics, the jig for firing ceramics were transported and subjected to a firing process at 2200° C. in a normal-pressure argon ambient atmosphere for about 3 hours so that porous silicon carbide sintered bodies having a square pillar shape were manufactured.

(5) Next, by using a heat resistant sealing material paste containing 30% by weight of alumina fibers having a fiber length of 0.2 mm, 21% by weight of silicon carbide particles having an average particle size of 0.6 μm, 15% by weight of silica sol, 5.6% by weight of carboxymethyl cellulose and 28.4% by weight of water, sixteen (4×4) square-pillar-shaped porous silicon carbide sintered bodies were combined with one another by using the above-mentioned method, and this was then cut by using a diamond cutter to form a cylindrical-shaped ceramic block having a diameter of 144 mm and a length of 150 mm.

Here, the porous silicon carbide sintered bodies that were used upon combining sixteen porous silicon carbide sintered bodies were those silicon carbide sintered bodies placed in the jig for firing ceramics on the same stage on the same supporting base or those silicon carbide sintered bodies placed on the same jig for firing ceramics.

Thus, twenty ceramic blocks, each of which was formed by using those silicon carbide sintered bodies placed in the jig for firing ceramics on the same stage on the same supporting base or those silicon carbide sintered bodies placed on the same jig for firing ceramics, were manufactured, and a ceramic filter was manufactured by using these ceramic blocks through a method, which will be described later.

After the above-mentioned process, ceramic fibers made from alumina silicate (shot content: 3%, fiber length: 0.1 to 100 mm) (23.3% by weight), which served as inorganic fibers, silicon carbide powder having an average particle size of 0.3 μm (30.2% by weight), which served as inorganic particles, silica sol (SiO₂ content in the sol: 30% by weight) (7% by weight), which served as an inorganic binder, carboxymethyl cellulose (0.5% by weight), which served as an organic binder, and water (39% by weight) were mixed and kneaded to prepare a sealing material paste.

Next, a sealing material paste layer of 1.0 mm in thickness was formed on the peripheral portion of the ceramic block by using the sealing material paste. Then, the sealing material paste layer was dried at 120° C. to manufacture a cylindrical-shaped ceramic filter.

Here, in the sealing material paste to be used upon combining the porous silicon carbide sintered bodies as well as in the sealing material paste to be applied to the periphery of the ceramic block, with respect to the inorganic fibers to be blended in the sealing material paste, the lower limit of the fiber length is preferably set to 5 μm and the upper limit of the fiber length is preferably set to 100 mm.

The fiber length less than 5 μm tends to cause insufficient elasticity in the resulting sealing material layer, while the fiber length exceeding 100 mm tends to cause the inorganic fibers to be pill-state fibers and the subsequent degradation in dispersion of the inorganic particles.

The upper limit of the fiber length of the inorganic fibers is preferably set to 100 μm. The fiber length of 100 μm or less easily makes the thickness of the sealing material layer thinner.

### Examples 2 to 7

The same processes as Example 1 were carried out, except that the rate of the areas of portions on the bottom face of the jig for firing ceramics in which through holes were formed in the jig for firing ceramics to the area on the bottom face of the jig for firing ceramics was changed as shown in Table 1, so that ceramic filters were manufactured.

### Examples 8 to 14

The same processes as Example 1 were carried out, except that the jig for firing ceramics was changed to the one shown in FIGS. 2A,B and that the rate of the areas of portions on the bottom face in which through holes were formed in the jig for firing ceramics to the area on the bottom face of the jig for firing ceramics was changed as shown in Table 1, so that ceramic filters were manufactured.

### Examples 15 to 21

The same processes as Example 1 were carried out, except that the jig for firing ceramics was changed to the one shown in FIG. 3 and that the rate of the areas of portions on the bottom face in which through holes and cut-out portions were formed in the jig for firing ceramics to the area on the bottom face of the jig for firing ceramics was changed as shown in Table 1, so that ceramic filters were manufactured.

### Examples 22 to 28

The same processes as Example 1 were carried out, except that the jig for firing ceramics was changed to the one shown in FIG. 4 and that the rate of the areas of portions on the bottom face in which cut-out portions were formed in the jig for firing ceramics to the area on the bottom face of the jig for firing ceramics was changed as shown in Table 1, so that ceramic filters were manufactured.

### Examples 29 to 35

The same processes as Example 1 were carried out, except that the jig for firing ceramics was changed to the one shown in FIGS. 5 A,B and that the rate of the areas of portions on the bottom face in which through holes and cut-out portions were formed in the jig for firing ceramics to the area on the bottom face of the jig for firing ceramics was changed as shown in Table 1, so that ceramic filters were manufactured.

### Examples 36 to 42

The same processes as Example 1 were carried out, except that the jig for firing ceramics was changed to the one shown in FIG. 6 A to C and that the rate of the areas of portions on the bottom face in which cut-out portions were formed in the jig for firing ceramics to the area on the bottom face of the jig for firing ceramics was changed as shown in Table 1, so that ceramic filters were manufactured.

### Examples 43 to 49

The same processes as Example 1 were carried out, except that the jig for firing ceramics was changed to the one shown in FIGS. 7 A,B, that the rate of the areas of portions on the bottom face in which through holes and cut-out portions were formed in the jig for firing ceramics to the area on the bottom face of the jig for firing ceramics was changed as shown in Table 1, and that jig for firing ceramics were piled up by using square tubular base-supporting members as shown in FIG. 7C, so that ceramic filters were manufactured.

### Example 50

The same processes as Example 4 were carried out except that the following material was used as the sealing material paste so that ceramic filters were manufactured.

With respect to the sealing material paste to be used for combining square-pillar-shaped porous silicon carbide sintered bodies, the material having the same composition (see (5) in Example 1) as used in Example 1 was used except that alumina fibers having a fiber length of 20 μm were blended in place of alumina fibers having a fiber length of 0.2 mm, and with respect to the sealing material paste to be used for forming the sealing material paste layer on the periphery of the ceramic block, the material having the same composition (see (5) in Example 1) as used in Example 1 was used except that ceramic fibers (shot content: 3%, fiber length: 5 to 100 μm) made from alumina silicate were blended as inorganic fibers.

### Comparative Example 1

The same processes as Example 1 were carried out, except that the jig for firing ceramics was changed to the one having a shape shown in FIG. 1 with no through hole formed in the bottom face, so that ceramic filters were manufactured.

Evaluation Test

(1) Average Pore Diameter

In compliance with JIS R 1655, by using a fine-pore distribution measuring device (AutoPore III9405, made by Shimadzu Corporation) in which a mercury press-in method is adopted, with respect to 50 porous silicon carbide sintered bodies in the respective jig for firing ceramics, manufactured in respective Examples 1 to 50 and Comparative Example 1, the center portion of each of the bodies is cut into a cube having 1 cm in each side to prepare a sample, and the fine-pore distribution was measured through the mercury press-in method in a range of the thin-pore diameter from 0.2 to 500 μm, and the average thin-pore diameter at this time was calculated (under a condition of 4V/A) so that the average value and standard deviation of the average fine-pore diameter were calculated. The results thereof are shown in Table 1.

(2) Strength

In compliance with JIS R 1601, with respect to 50 porous silicon carbide sintered bodies in the respective jig for firing ceramics manufactured in respective Examples 1 to 50 and Comparative Example 1, each of the bodies was subjected to a bending strength test using three bending points under conditions of a cross head speed of 0.5 mm/min and a span of 125 mm, by using a measuring device, Instron 5582, and the cross-sectional secondary moment was calculated to obtain the strength. The average values are shown in Table 1. The contents of JIS R 1601 are incorporated herein by reference in their entirety.

(3) Measurements on Pressure Loss

With respect to 20 ceramic filters relating to Examples 1 to 50 and Comparative Example 1 manufactured by using those porous silicon carbide sintered bodies placed in the jig for firing ceramics on the same stage on the same supporting base or those silicon carbide sintered bodies placed on the same jig for firing ceramics, each of the sintered bodies was measured in its initial pressure loss under a flow rate of 1000 N·m³/h, and standard deviations thereof were calculated. The results thereof are shown in Table 1.

TABLE 1-1

| | | Rate of | Ceramic filter | | | | |
|---|---|---|---|---|---|---|---|
| | | area of | | Standard | | Standard | |
| | | through | | deviation | | deviation | |
| | | Hole | Average | of | Initial | of | |
| | | and/or | pore | average | pressure | initial | Filter |
| | Used | cut-out | diameter | pore | loss | pressure | strength |
| | jig | portion | (μm) | diameter | (kPa) | loss | (MPa) |
| Example 1 | | 0.5 | 10.1 | 0.9 | 16.3 | 0.33 | 47 |
| Example 2 | | 10 | 10.4 | 0.8 | 16.1 | 0.26 | 46 |
| Example 3 | | 20 | 10.5 | 0.8 | 16.0 | 0.26 | 46 |
| Example 4 | | 30 | 10.5 | 0.8 | 16.0 | 0.25 | 46 |
| Example 5 | | 40 | 10.3 | 0.8 | 16.0 | 0.22 | 44 |
| Example 6 | | 60 | 10.0 | 0.7 | 17.6 | 0.21 | 42 |
| Example 7 | | 70 | 8.8 | 0.6 | 18.5 | 0.18 | 34 |
| Example 8 | | 0.5 | 10.2 | 0.9 | 16.2 | 0.38 | 48 |
| Example 9 | | 10 | 10.1 | 0.8 | 16.1 | 0.27 | 46 |
| Example 10 | | 20 | 10.5 | 0.8 | 16.0 | 0.26 | 46 |
| Example 11 | | 30 | 10.5 | 0.8 | 16.0 | 0.24 | 45 |
| Example 12 | | 40 | 10.4 | 0.7 | 16.5 | 0.21 | 44 |
| Example 13 | | 60 | 10.1 | 0.7 | 17.5 | 0.20 | 41 |
| Example 14 | | 70 | 8.8 | 0.6 | 18.4 | 0.19 | 35 |
| Example 15 | | 0.5 | 10.1 | 0.8 | 16.0 | 0.35 | 46 |
| Example 16 | | 10 | 10.1 | 0.8 | 16.1 | 0.27 | 46 |
| Example 17 | | 20 | 10.4 | 0.8 | 16.1 | 0.27 | 44 |
| Example 18 | | 30 | 10.5 | 0.7 | 16.3 | 0.25 | 44 |
| Example 19 | | 40 | 10.4 | 0.7 | 16.5 | 0.22 | 44 |
| Example 20 | | 60 | 10.0 | 0.7 | 17.7 | 0.20 | 42 |
| Example 21 | | 70 | 8.8 | 0.6 | 18.6 | 0.20 | 34 |
| Example 22 | | 0.5 | 10.3 | 0.9 | 16.1 | 0.33 | 47 |
| Example 23 | | 10 | 10.2 | 0.8 | 16.1 | 0.25 | 45 |
| Example 24 | | 20 | 10.4 | 0.8 | 16.0 | 0.25 | 45 |
| Example 25 | | 30 | 10.5 | 0.7 | 16.2 | 0.24 | 45 |
| Example 26 | | 40 | 10.5 | 0.8 | 16.6 | 0.20 | 44 |
| Example 27 | | 60 | 10.2 | 0.7 | 17.6 | 0.20 | 40 |
| Example 28 | | 70 | 9.0 | 0.7 | 18.5 | 0.18 | 33 |

TABLE 1-2

| | | Rate of | Ceramic filter | | | | |
|---|---|---|---|---|---|---|---|
| | | area of | | Standard | | Standard | |
| | | through | | deviation | | deviation | |
| | | Hole | Average | of | Initial | of | |
| | | and/or | pore | average | pressure | initial | Filter |
| | Used | cut-out | diameter | pore | loss | pressure | strength |
| | jig | portion | (μm) | diameter | (kPa) | loss | (MP) |
| Example 29 | | 0.5 | 10.2 | 0.7 | 16.1 | 0.34 | 48 |
| Example 30 | | 10 | 10.1 | 0.8 | 16.1 | 0.26 | 46 |
| Example 31 | | 20 | 10.5 | 0.7 | 16.1 | 0.26 | 46 |
| Example 32 | | 30 | 10.5 | 0.8 | 16.1 | 0.24 | 46 |
| Example 33 | | 40 | 10.4 | 0.7 | 16.6 | 0.22 | 43 |
| Example 34 | | 60 | 10.1 | 0.7 | 17.5 | 0.21 | 42 |
| Example 35 | | 70 | 8.8 | 0.7 | 18.5 | 0.19 | 34 |
| Example 36 | | 0.5 | 10.2 | 0.8 | 16.2 | 0.37 | 47 |
| Example 37 | | 10 | 10.1 | 0.8 | 16.2 | 0.29 | 45 |
| Example 38 | | 20 | 10.5 | 0.8 | 16.0 | 0.25 | 46 |
| Example 39 | | 30 | 10.5 | 0.8 | 16.1 | 0.24 | 44 |
| Example 40 | | 40 | 10.4 | 0.7 | 16.4 | 0.24 | 44 |
| Example 41 | | 60 | 10.1 | 0.8 | 17.4 | 0.22 | 40 |
| Example 42 | | 70 | 8.9 | 0.6 | 18.4 | 0.18 | 33 |
| Example 43 | | 0.5 | 10.1 | 0.9 | 16.0 | 0.33 | 46 |
| Example 44 | | 10 | 10.3 | 0.9 | 16.1 | 0.30 | 44 |
| Example 45 | | 20 | 10.4 | 0.8 | 16.0 | 0.29 | 44 |
| Example 46 | | 30 | 10.5 | 0.8 | 16.2 | 0.28 | 44 |
| Example 47 | | 40 | 10.3 | 0.8 | 16.3 | 0.25 | 44 |
| Example 48 | | 60 | 10.3 | 0.8 | 17.3 | 0.24 | 39 |
| Example 49 | | 70 | 9.0 | 0.7 | 18.7 | 0.22 | 34 |
| Example 50 | | 30 | 10.4 | 0.8 | 16.1 | 0.25 | 45 |
| Compar. | | 0 | 9.1 | 1.2 | 16.1 | 0.45 | 48 |
| Example 1 | | | | | | | |

As clearly indicated by the results shown in Table 1, in any of the porous silicon carbide sintered bodies relating to Examples 1 to 50, the average pore diameter and the initial pressure loss tend to have dispersions in comparison with the average pore diameter and the initial pressure loss of the porous silicon carbide sintered body relating to Comparative Example 1.

Moreover, as clearly indicated by Examples, the present invention is preferably applied to a manufacturing process for a porous carbide ceramic filter, and in particular, is preferably applied to a manufacturing process for a porous silicon carbide ceramic filter.

What is claimed as new and desired to be secured by Letters Patent of the United States is:

1. A jig for firing ceramics, which is used by being piled up in multiple stages upon firing a ceramic formed body,
having
a through hole and/or a cut-out portion formed in a portion thereof.

2. The jig for firing ceramics according to claim 1,
having
a box shape with its upper face opened.

3. The jig for firing ceramics according to claim 2,
wherein
the through hole and/or cut-out portion are/is formed only in a bottom face.

4. The jig for firing ceramics according to claim 2,
wherein
the through hole and/or cut-out portion are/is formed in a bottom face and a wall portion.

5. The jig for firing ceramics according to claim 1,
which is configured by:
a substantially rectangular-shaped bottom portion; and
wall portions formed on opposing two sides of the rectangular shape.

6. The jig for firing ceramics according to claim 5,
wherein
the through hole and/or cut-out portion are/is formed only in the bottom face.

7. The jig for firing ceramics according to claim 1,
which is configured by:
a rectangular-shaped bottom portion; and
pillar-shaped portions formed on four corners of said rectangular shape.

8. The jig for firing ceramics according to claim 7,
wherein
the through hole and/or cut-out portion are/is formed in the bottom face.

9. The jig for firing ceramics according to claim 1,
having
a flat plate shape.

10. The jig for firing ceramics according to claim 1,
wherein
said through hole and/or cut-out portion are/is formed in the bottom face of said jig for firing ceramics, and
the area of the portion on the bottom face of said jig for firing ceramics in which said through hole and/or cut-out portion are/is formed occupies about 0.5% to about 60% of the area of said bottom face.

11. The jig for firing ceramics according to claim 10,
wherein
the area of the portion on the bottom face of said jig for firing ceramics in which said through hole and/or cut-out portion are/is formed occupies about 10% to about 40% of the area of said bottom face.

12. The jig for firing ceramics according to claim 10,
wherein
the area of the portion on the bottom face of said jig for firing ceramics in which said through hole and/or cut-out portion are/is formed occupies about 10% to about 30% of the area of said bottom face.

13. The jig for firing ceramics according to claim 1,
wherein
the through hole of said jig for firing ceramics has a rectangular shape with R-portions formed on corner portions of the rectangular shape, a rectangular shape with C-chamfered faces formed on corner portions of the rectangular shape, a round shape, a rectangular shape, a triangular shape, a pentagonal shape or an elliptical shape.

14. The jig for firing ceramics according to claim 1,
having
a carbon-powder holding area at a portion of said bottom face.

15. A manufacturing method for a porous ceramic body,
in which,
after a pillar-shaped ceramic formed body containing ceramic powder and a binder has been degreased, the pillar-shaped ceramic formed body is placed in a jig for firing and fired,
comprising the step of:
using a jig for firing ceramics having a through hole and/or a cut-out portion formed in a portion thereof, by piling it up in multiple stages as said jig for firing.

16. The manufacturing method for a porous ceramic body according to claim 15,
wherein
said jig for firing ceramics has a box shape with its upper face opened.

17. The manufacturing method for a porous ceramic body according to claim 15,
wherein
said jig for firing ceramics is configured by:
a rectangular-shaped bottom portion; and
wall portions formed on opposing two sides of the rectangular shape.

18. The manufacturing method for a porous ceramic body according to claim 15,
wherein
said jig for firing ceramics is configured by:
a rectangular-shaped bottom portion; and
pillar-shaped portions formed on four corners of the rectangular shape.

19. The manufacturing method for a porous ceramic body according to claim 15,
wherein
said jig for firing ceramics which has a flat plate shape is used by piling it up in multiple stages through a square tubular base supporting member.

20. The manufacturing method for a porous ceramic body according to claim 15,
wherein
said through hole and/or cut-out portion are/is formed in the bottom face of the jig for firing ceramics, and
the area of the portion on the bottom face of said jig for firing ceramics in which said through hole and/or cut-out portion are/is formed occupies about 0.5% to about 60% of the area of said bottom face.

21. The manufacturing method for a porous ceramic body according to claim 20,
wherein
the area of the portion on the bottom face of said jig for firing ceramics in which said through hole and/or cut-out portion are/is formed occupies about 10% to about 40% of the area of said bottom face.

22. The manufacturing method for a porous ceramic body according to claim 20,
wherein
the area of the portion on the bottom face of said jig for firing ceramics in which said through hole and/or cut-out portion are/is formed occupies about 10% to about 30% of the area of said bottom face.

23. The manufacturing method for a porous ceramic body according to claim 15,
wherein
said jig for firing ceramics has a carbon-powder holding area in the bottom face.

24. A porous ceramic body manufactured
in such a manner that,
after a pillar-shaped ceramic formed body containing ceramic powder and a binder has been degreased,
the degreased pillar-shaped ceramic formed body is placed in a jig for firing and fired,
wherein
sintering is conducted in condition that:
said degreased ceramic formed body is placed in a jig for firing ceramics having a through hole and/or a cut-out portion formed in a portion thereof; and
said jigs for firing ceramics on which said ceramic formed body is placed are piled up in multiple stages.

25. The porous ceramic body according to claim 24,
wherein
said jig for firing ceramics has a box shape with its upper face opened.

26. The porous ceramic body according to claim 24,
said jig for firing ceramics is configured by:
a rectangular-shaped bottom portion; and
wall portions formed on opposing two sides of the rectangular shape.

27. The porous ceramic body according to claim 24,
said jig for firing ceramics is configured by:
a rectangular-shaped bottom portion; and
pillar-shaped portions formed on four corners of the rectangular shape.

28. The porous ceramic body according to claim 24,
wherein
said jigs for firing ceramics which has a flat plate shape are fired by piling it up in multiple stages through a square tubular base-supporting member.

29. The porous ceramic body according to claim 24,
wherein
said through hole and/or cut-out portion are/is formed in the bottom face of said jig for firing ceramics, and
the area of the portion on the bottom face of said jig for firing ceramics in which said through hole and/or cut-out portion are/is formed occupies about 0.5% to about 60% of the area of said bottom face.

30. The porous ceramic body according to claim 29,
wherein
the area of the portion on the bottom face of said jig for firing ceramics in which said through hole and/or cut-out portion are/is formed occupies about 10% to about 40% of the area of said bottom face.

31. The porous ceramic body according to claim 29,
wherein
the area of the portion on the bottom face of said jig for firing ceramics in which said through hole and/or cut-out portion are/is formed occupies about 10% to about 30% of the area of said bottom face.
